(19) United States
(12) Patent Application Publication
(10) Pub. No.: US 2005/0079129 A1
(43) Pub. Date: Apr. 14, 2005

(54) Rapid chemical charging of metal hydrides

(76) Inventors: Srinivasan Venkatesan, Southfield, MI (US); Stanford R. Ovshinsky, Bloomfield Hills, MI (US); Subhash K. Dhar, Bloomfield Hills, MI (US); Hong Wang, Troy, MI (US)

Correspondence Address: ENERGY CONVERSION DEVICES, INC., 2956 WATERVIEW DRIVE, ROCHESTER HILLS, MI, 48309, US

(21) Appl. No.: 10/684,616

(22) Filed: Oct. 14, 2003

(51) Int. Cl. C01B 3/06

(52) U.S. Cl. 423/658.2

(57) ABSTRACT

The present invention discloses a method and system for charging a metal hydride bed, wherein the metal hydride bed contains a hydrogen storage material. The metal hydride bed is charged using a chemical hydride slurry having a metal hydride, a stabilizing agent and water. As the slurry contacts the metal hydride bed, a catalyst in the metal hydride bed promotes a reaction between the metal hydride of the slurry and water. The reaction produces atomic hydrogen and byproducts. At least a portion of the atomic hydrogen is absorbed by the hydrogen storage material and the remaining atomic hydrogen is disposed from the system or used as fuel in a hydrogen fueled apparatus, such as a fuel cell.

### FIELD OF THE INVENTION

The present invention relates to a process and system for charging solid metal hydrides comprising hydrogen storage material. More particularly, the present invention relates to a process in which a slurry of chemical hydride charges a hydrogen storage alloy by decomposing at the surface of the alloy and releasing hydrogen gas that is absorbed by the hydrogen storage material.

### BACKGROUND OF THE INVENTION

Hydrogen is the “ultimate fuel” for the next millennium, and, it is inexhaustible. Hydrogen is the most plentiful element in the universe and can provide an inexhaustible, clean source of energy for our planet, which can be produced by various processes which split water into hydrogen and oxygen. The hydrogen can be stored and transported in solid state form.

In the past considerable attention has been given to the use of hydrogen as a fuel or fuel supplement. While the world's oil reserves are depletable, the supply of hydrogen remains virtually unlimited. Hydrogen can be produced from coal, natural gas and other hydrocarbons, or formed by the electrolysis of water, preferably via energy from the sun which is composed mainly of hydrogen and can, itself, be thought of as a giant hydrogen “furnace”. Moreover hydrogen can be produced without the use of fossil fuels, such as by the electrolysis of water using nuclear or solar energy, or any other form of economical energy (e.g., wind, waves, geothermal, etc.). Furthermore, hydrogen, is an inherently low cost fuel. Hydrogen has the highest density of energy per unit weight of any chemical fuel and is essentially non-polluting since the main by-product of “burning” hydrogen is water. Thus, hydrogen can be a means of solving many of the world's energy related problems, such as climate change, pollution, strategic dependency on oil, etc., as well as providing a means of helping developing nations.

The earliest work at atomic engineering of hydrogen storage materials is disclosed by Stanford R. Ovshinsky in U.S. Pat. No. 4,623,597 (“the '597 patent”), the contents of which are incorporated by reference. Ovshinsky, described disordered multi-component hydrogen storage materials for use as negative electrodes in electrochemical cells for the first time. In this patent, Ovshinsky describes how disordered materials can be tailor made to greatly increase hydrogen storage and reversibility characteristics. Such disordered materials are formed of one or more of amorphous, microcrystalline, intermediate range order, or polycrystalline (lacking long range compositional order) wherein the polycrystalline material may include one or more of topological, compositional, translational, and positional modification and disorder, which can be designed into the material. The framework of active materials of these disordered materials consist of a host matrix of one or more elements and modifiers incorporated into this host matrix. The modifiers enhance the disorder of the resulting materials and thus create a greater number and spectrum of catalytically active sites and hydrogen storage sites.

The disordered electrode materials of the '597 patent were formed from lightweight, low cost elements by any number of techniques, which assured formation of primarily non-equilibrium meta-stable phases resulting in the high energy and power densities and low cost. The resulting low cost, high energy density disordered material allowed the development of Ovonic batteries to be utilized most advantageously as secondary batteries, but also as primary batteries and are used today worldwide under license from the assignee of the subject invention.

Tailoring of the local structural and chemical order of the materials of the '597 patent was of great importance to achieve the desired characteristics. The improved characteristics of the anodes of the '597 patent were accomplished by manipulating the local chemical order and hence the local structural order by the incorporation of selected modifier elements into a host matrix to create a desired disordered material. The disordered material had the desired electronic configurations which resulted in a large number of active sites. The nature and number of storage sites was designed independently from the catalytically active sites.

Multi-orbital modifiers, for example transition elements, provided a greatly increased number of storage sites due to various bonding configurations available, thus resulting in an increase in energy density. The technique of modification especially provides non-equilibrium materials having varying degrees of disorder provided unique bonding configurations, orbital overlap and hence a spectrum of bonding sites. Due to the different degrees of orbital overlap and the disordered structure, an insignificant amount of structural rearrangement occurs during charge/discharge cycles or rest periods there between resulting in long cycle and shelf life.

The improved battery of the '597 patent included electrode materials having tailor-made local chemical environments which were designed to yield high electrochemical charging and discharging efficiency and high electrical charge output. The manipulation of the local chemical environment of the materials was made possible by utilization of a host matrix which could, in accordance with the '597 patent, be chemically modified with other elements to create a greatly increased density of catalytically active sites for hydrogen dissociation and also of hydrogen storage sites.

The disordered materials of the '597 patent were designed to have unusual electronic configurations, which resulted from the varying 3-dimensional interactions of constituent atoms and their various orbitals. The disorder came from compositional, positional and translational relationships of atoms. Selected elements were utilized to further modify the disorder by their interaction with these orbitals so as to create the desired local chemical environments.

The internal topology that was generated by these configurations also allowed for selective diffusion of atoms and ions. The invention that was described in the '597 patent made these materials ideal for the specified use since one could independently control the type and number of catalytically active and storage sites. All of the aforementioned properties made not only an important quantitative difference, but qualitatively changed the materials so that unique new materials ensued.

The disorder described in the '597 patent can be of an atomic nature in the form of compositional or configurational disorder provided throughout the bulk of the material or in numerous regions of the material. The disorder also can be introduced into the host matrix by creating microscopic phases within the material which mimic the compositional or configurational disorder at the atomic level by virtue of the relationship of one phase to another. For example, disordered materials can be created by introducing microscopic regions of a different kind or kinds of crystalline phases, or by introducing regions of an amorphous phase or phases, or by introducing regions of an amorphous phase or phases in addition to regions of a crystalline phase or phases. The interfaces between these various phases can provide surfaces which are rich in local chemical environments which provide numerous desirable sites for electrochemical hydrogen storage.

These same principles can be applied within a single structural phase. For example, compositional disorder is introduced into the material, which can radically alter the material in a planned manner to achieve important improved and unique results, using the Ovshinsky principles of disorder on an atomic or microscopic scale.

One advantage of the disordered materials of the '597 patent were their resistance to poisoning. Another advantage was their ability to be modified in a substantially continuous range of varying percentages of modifier elements. This ability allows the host matrix to be manipulated by modifiers to tailor-make or engineer hydrogen storage materials with all the desirable characteristics, i.e., high charging/discharging efficiency, high degree of reversibility, high electrical efficiency, long cycle life, high density energy storage, no poisoning and minimal structural change.

Typically hydrogen is produced by a variety of methods such as water electrolysis or steam reforming or cracking hydrocarbons or ammonia. In all these cases the hydrogen that is produced is dried and cleaned of all contaminants and then either compressed at high pressure or liquefied or stored in an alloy as metal hydrides. All methods have some pros and cons. However it is recognized that the purest form of hydrogen comes from water electrolysis. All other methods either use fossil fuels or are energy intensive. Those methods that use fossil fuels have a built-in disadvantage in that they do produce carbon monoxide and carbon dioxide. In addition fossil fuels availability is limited and the remaining reserves are better used for other industrial chemical use than being burnt as fuel. Water electrolysis is preferable, because there is plenty of water and there is no pollution. Although currently deemed to be energy intensive, water electrolysis can be performed using electricity from any source such as off peak power, or solar power or wind power.

Irrespective of the method of production, once hydrogen is produced, it can be transported either via pipelines or by onsite liquefaction and transport as cryogenic hydrogen or compressed in high pressure tube trailers or transported as solid hydrides and regenerated at the site by simple heating. There are no transmission pipeline infrastructure existing at present. Liquefaction is expensive and liquid hydrogen is highly dangerous to be transported in tankers. Compressed gas, especially at the pressures currently being proposed, is also dangerous. Therefore, hydrogen storage appears to be the best option. For this option, hydride materials are exposed to hydrogen at a higher pressure (>10 atmospheres) repeatedly. The hydrogen is absorbed and being an exothermic reaction heat is generated. However, heat must be removed to complete the absorption. Once the hydride is formed, hydrogen is released at the desired site, by heating the hydride.

In a hydrogen based economy, automobiles running on fuel cell supplied with hydrogen fuel or automobiles running on ICE running on hydrogen fuel is certainly going to be common. Hydride based hydrogen storage is the best option because of the safety considerations and ease of operation. One of the important considerations in successful implementation of this option is the charging the hydrogen in to the hydride. Hydrogen absorption is an exothermic reaction and releases a lot of energy in the form of heat (roughly 8-9 kJ/Kg). This heat must to be removed to let the hydriding proceed. This implies pumping in a large quantity of coolant along with (or simultaneously with) hydrogen charging. The impracticality of this approach becomes apparent when a typical automobile needs to carry 5 to 6 kG of hydrogen to run about 300 miles and the total heat energy that needs to be removed is approximately equivalent to 1 mega joule.

Prior art devices have proposed using hydrogen production principles to provide the fuel for a hydrogen consuming device. U.S. Pat. No. 6,534,033 issued to Amendola et al. on Mar. 18, 2003 (herein after “'033 patent”) discloses a system for the controlled release of hydrogen by incorporating a metal hydride solution and a hydrogen generation catalyst system. Further, the '033 patent provides a containment system for the catalyst of the catalyst system that separates the catalyst and stabilized metal hydride solution until such time that the desired chemical reaction is to take place. However, the '033 patent does not disclose a system which is adapted to release hydrogen for absorption into a hydrogen storage metal hydride bed to charge the bed.

Currently, there exists a need in the art for a process that simultaneously releases hydrogen from a slurry wherein the hydrogen is immediately absorbed by a hydrogen storage alloy to charge the alloy. The present invention discloses a method for the rapid chemical charging of metal hydrides without the use of high pressure hydrogen. The present invention incorporates a chemical hydride slurry contacting the surface of a hydrogen storage alloy causing the chemical hydride slurry to decompose to release atomic hydrogen in close proximity of the hydrogen absorber. The atomic hydrogen is then absorbed to charge the hydrogen storage alloy and excess hydrogen provides fuel for a hydrogen powered apparatus.

### SUMMARY OF THE INVENTION

An embodiment of the present invention discloses a method for charging a metal hydride bed having a hydrogen storage material. A first container is provided, wherein the first container is in flow communication with a second container. A chemical hydride slurry is poured into or otherwise provided in the first container. The chemical hydride slurry comprises a metal hydride, a stabilizing agent and water. The metal hydride bed is provided in the second container. The metal hydride bed comprises a hydrogen storage material having a hydrogen generation catalyst. The chemical hydride slurry is forced into contact with the metal hydride bed in said second container. The catalyst of the metal hydride bed promotes a reaction between the metal hydride of the slurry and the water, causing a release of atomic hydrogen from the slurry. If the hydrogen storage bed were not present, the atomic hydrogen has no option but to recombine with another atomic hydrogen and escape as molecular hydrogen. By providing the hydrogen absorber at the site of atomic hydrogen generation, efficient hydride formation is promoted. The hydrogen storage material of the metal hydride bed absorbs at least a portion of the atomic hydrogen. Atomic hydrogen that is not absorbed by the hydrogen storage material of the metal hydride bed may recombine and be vented from the second container for disposal or used to power a hydrogen powered apparatus, such as a fuel cell. The products of the reaction within the slurry may be pumped away from the metal hydride bed. However, unreacted metal hydride in the slurry may be pumped, with the products, back to the first container. The cycle may be repeated until all the metal hydride has reacted and all the hydrogen has been released from the slurry.

An embodiment of the present invention provides a process for releasing hydrogen from a chemical hydride slurry and immediately absorbing the released hydrogen into a hydrogen storage alloy. A chemical hydride slurry is released onto hydrogen absorbing alloy containing a hydrogen releasing catalyst. The chemical hydride slurry decomposes upon contact with the alloy and atomic hydrogen is released. The atomic hydrogen is then absorbed into the alloy and excess hydrogen that is not absorbed into the alloy may recombine as molecular hydrogen and may be used to operate a hydrogen powered apparatus, such as a fuel cell.

An embodiment of the present invention discloses a process and system for charging a solid metal hydride, wherein the amount of hydriding can be pre determined by adjusting the concentration of the metal hydride in the chemical hydride slurry.

An embodiment of the present invention discloses a process and system for charging a solid metal hydride, wherein there will be a rationed in/rationed out hydrogen supply.

An embodiment of the present invention discloses a process and system for charging a solid metal hydride, wherein heat dissipation will become less of a problem, because the gradual introduction of the atomic hydrogen leading to progressive hydriding rather than hydriding all at once causes a gradual increase in temperature, additionally because the water in the slurry helps to dissipate the heat.

An embodiment of the present invention discloses a process and system for charging a solid metal hydride, wherein the excess hydrogen storage capacity in the metal borohydride replenishes the hydrogen used up in the metal hydride bed.

An embodiment of the present invention discloses a process and system for charging a solid metal hydride, wherein the process continues until all the metal hydride decomposes and releases the atomic hydrogen contained in the chemical hydride slurry.

An embodiment of the present invention discloses a process and system for charging a solid metal hydride, wherein the metal hydride bed will not be oxidized and always be fresh to receive hydrogen (activated), since the metal hydride of the slurry is a reducing agent and will keep the metal hydride bed from getting oxidized.

An embodiment of the present invention discloses a process and system for charging a solid metal hydride, wherein no extra precautions at the filling station relating to the dangers associated with hydrogen gas are necessary, because the slurry is a liquid that is pumped thus simulating the current day process of “fuel fill up”.

### BRIEF DESCRIPTION OF THE DRAWINGS

In order to assist in the understanding of the various aspects of the present invention and various embodiments thereof, reference is now be made to the appended drawings, in which like reference numerals refer to like elements. The drawings are exemplary only, and should not be construed as limiting the invention.

FIG. 1 is an illustration of an embodiment of the present invention that incorporates a metal hydride slurry flowing to a metal hydride bed;

FIG. 2 is a graphical illustration of a negative electrode activation curve of sodium borohydride in potassium hydroxide;

FIG. 3 is a graphical illustration of electrode potential of potassium hydroxide;

FIG. 4 is a graphical illustration of a negative electrode polarization curve of sodium borohydride in potassium hydroxide; and

FIG. 5 is a graphical illustration of a negative electrode discharging capacity of sodium borohydride in potassium hydroxide.

### DETAILED DESCRIPTION OF THE INVENTION

The present invention discloses a process and system for charging a metal hydride bed using chemical hydride slurry, wherein the metal hydride bed contains a hydrogen storage material and catalysts to release atomic hydrogen from the slurry. The atomic hydrogen is absorbed by and stored in the hydrogen storage material upon release from the slurry. The metal hydride bed charging process of the present invention eliminates the need for a separate cooling step or apparatus as the hydrogen storage material absorbs the atomic hydrogen released from the slurry.

The chemical hydride slurry of the present invention may include a metal hydride, such as sodium borohydride, a stabilizing agent, such as potassium hydroxide, and water. The metal hydride of the slurry reacts with the water to produce atomic hydrogen. Catalysts are incorporated to activate the reaction between metal hydride of the slurry and water.

Examples of metal hydrides to be used in accordance with the present invention include, but are not limited to, NaBH₄, LiBH₄, KBH₄, NH₄BH₄, (CH₃)₄NH₄BH₄, NaAlH₄, LiAlH₄, KAlH₄, NaGaH₄, LiGaH₄, KGaH₄, and mixtures thereof. Typically, borohydrides are most stable in water, i.e., the metal hydrides do not readily decompose when in contact with water. Preferred borohydrides are sodium borohydride (NaBH₄), lithium borohydride (LiBH₄), potassium borohydride (KBH₄), ammonium borohydride (NH₄BH₄), tetramethyl ammonium borohydride ((CH₃)₄NH₄BH₄), quaternary borohydrides, and mixtures thereof. Sodium borohydride is the most preferred borohydride.

Hydrogen gas (H₂) and borate (BO₂⁻) are generated by reacting borohydride with water, as illustrated by chemical reaction below.
BH₄⁻+2H₂O═BO₂⁻+4H₂

However, this chemical reaction occurs very slowly unless a catalyst is used. Prior art generation catalysts based on Ruthenium metal are somewhat expensive. Any impurity in the fluid is likely to poison the effectiveness of these catalysts. In the above reaction the product, the borate, is non-toxic and environmentally safe. In addition, borate can be regenerated into borohydride. In the present invention, the atomic hydrogen is absorbed into a hydrogen storage material and the product borate and any un-reacted boro-hydride is pumped away from a metal hydride bed having the hydrogen storage material. Preferably, the un-reacted boro-hydride is cycled back into contact with the metal hydride bed and the cycle is repeated until all the borohydride has reacted with water and all the hydrogen has been released from the slurry. It is important to note that all of the hydrogen present in borohydride and water are converted to hydrogen gas, and that half the hydrogen gas produced by reaction actually comes from the water.

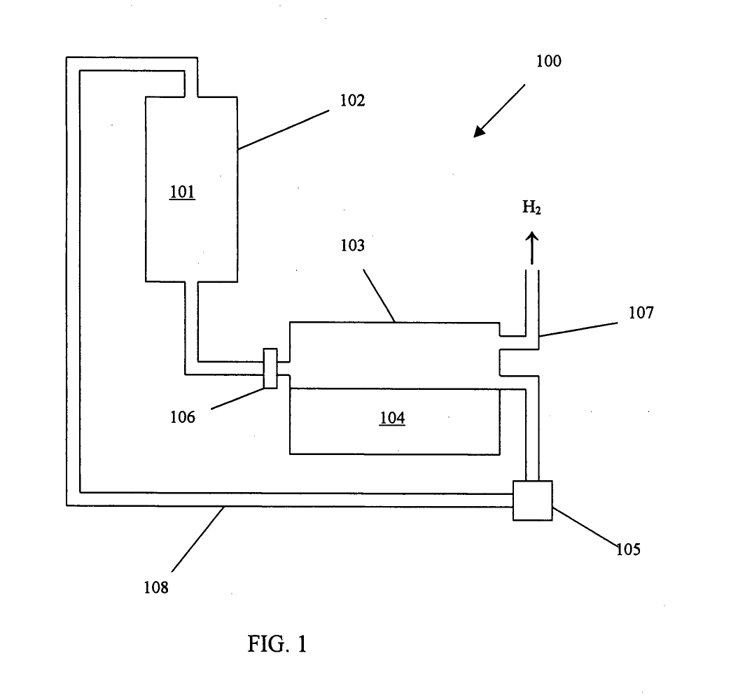

In a preferred embodiment, chemical hydride slurry 101 is pumped into a container 103 having a metal hydride bed 104, as illustrated in FIG. 1. A container having chemical hydride slurry is set in flow communication with a metal hydride bed. A valve 106 may be set between the slurry container 102 and the metal hydride bed container 103 to control the flow of slurry from the slurry container 102 to the metal hydride bed container 103. The slurry 101 charges the metal hydride bed 104 as the slurry 101 flows over the bed 104. As the metal hydride in the slurry 101 reacts with water in the slurry 101, with the aid catalysts contained within the bed 104, hydrogen gas is absorbed into hydrogen absorbing material contained within the bed 104. Hydrogen that is not released from the slurry flows from the metal hydride bed container 103. The excess hydrogen released from the slurry but not absorbed by the metal hydride bed 104 may be purged from the metal hydride bed container 103 or used as fuel in a hydrogen powered apparatus. A vent 107 may be set to provide an avenue for the hydrogen gas to flow out of the metal hydride bed container 103. Preferably, the vent 107 is set on the top side of the container, because the hydrogen gas will have a tendency to rise. A pump 105 is adapted to force the slurry 101 through the system 100. Un-reacted slurry 108 is pumped back to the slurry container 102. The process continues until all metal hydride has reacted with the water contained therein and the hydrogen gas has been removed from the slurry. When all the hydrogen gas has been removed from the slurry, the valve 106 set between the slurry container 102 and the metal hydride bed container 103 may be closed and the byproducts of the slurry container 102 removed. Then, fresh slurry having the metal hydride, stabilizer and water may be put in the slurry container 102 and the process may be started again.

The chemical hydride slurry contacts the metal hydride bed and decomposes to produce atomic hydrogen. Preferably, the metal hydride bed contains a hydrogen absorbing material and at least one catalyst to facilitate the release of hydrogen in the metal hydride slurry. Since the hydrogen is being discharged at the surface of the metal hydride bed, the atomic hydrogen will be immediately absorbed forming a hydride. Since the metal hydride is not being exposed to hydrogen in a large quantity, a sudden rise in temperature is unlikely. Further, the rate of decomposition of the borohydride will set the pace of hydriding of the alloy bed. The presence of water will also act as a coolant keeping the reaction going as the slurry flows across the metal hydride bed.

The metal hydride bed may comprise a hydrogen storage material, preferably a metal hydride, such as those described in U.S. patent application Ser. No. 10/247,536 entitled “High Capacity Transition Metal Based Hydrogen Storage Materials for the Reversible Storage of Hydrogen” filed by Sapru et al. on Sep. 18, 2002; U.S. Pat. No. 6,193,929 entitled “High Storage Capacity Alloys Enabling a Hydrogen-Based Ecosystem” issued to Ovshinsky, et al. on Feb. 27, 2001; U.S. Pat. No. 4,832,913 entitled “Hydrogen Storage Materials Useful for Heat Pump Applications” issued to Hong, et al. on May 23, 1989, all of which are hereby incorporated herein by reference. The hydrogen storage material may be selected from Rare-earth/Misch metal alloys, zirconium alloys, titanium alloys, and mixtures or alloys thereof, which may be AB, A₂B, AB₂, AB₅ type alloys or a mixture thereof.

The hydrogen storage material may include one or more metallic materials capable of storing hydrogen in metal hydride form. Preferably, the metal hydride bed comprises an alloy that acts as both a hydrogen storage material and a catalyst. The metallic materials may be selected from Mg, Mg—Ni, Mg—Cu, Ti—Fe, Ti—Ni, Mm—Co, Ti—Mn, Ti—V, Ti—Cr, Mm—Ni based alloy systems (wherein, Mm is Misch metal, which is a rare-earth metal or combination/alloy of rare-earth metals), or a combination thereof. The hydrogen storage material may be alloys based on the above metallic materials.

Of these metals, the Mg alloy systems can store relatively large amounts of hydrogen per unit weight of the storage material. However, heat energy must be supplied to release the hydrogen stored in the alloy, because of its low hydrogen dissociation equilibrium pressure at room temperature. Moreover, release of hydrogen can be made, only at a high temperature of over 250° C. along with the consumption of large amounts of energy.

The Ti—Fe alloy system, which has been considered as a typical and superior material of the titanium alloy systems, has the advantages that it is relatively inexpensive and the hydrogen dissociation equilibrium pressure of hydrogen is several atmospheres at room temperature. However, since it requires a high temperature of about 350° C. and a high pressure of over 30 atmospheres for initial hydrogenation, the alloy system provides relatively low hydrogen absorption/desorption rate. Also, it has considerable hysteresis indicating a lack of complete reversibility problem, which hinders the complete release of hydrogen stored therein.

Since the present invention is designed for use at ambient temperature, the hydrogen storage alloy for the present invention is preferably a Ti—Mn alloy. This alloy has excellent room temperature kinetics and plateau pressures. The Ti—Mn alloy system has been reported to have a high hydrogen-storage efficiency and a proper hydrogen dissociation equilibrium pressure, since it a high affinity for hydrogen and low atomic weight to allow large amounts of hydrogen-storage per unit weight.

A generic formula for the Ti—Mn alloy is: Ti_{Q-Z}Zr_{X}Mn_{Z-Y}A_{Y}, where A is generally one or more of V, Cr, Fe, Ni and Al. Most preferably A is one or more V, Cr and Fe. The subscript Q is preferably between 0.9 and 1.1, most preferably Q is 1.0. The subscript X is between 0.0 and 0.35, more preferably X is between 0.1 and 0.2, and most preferably X is between 0.1 and 0.15. The subscript Y is between 0.6 and 1.8, more preferably Y is between 0.6 and 1.2, and most preferably Y is between 0.6 and 1.0. The subscript Z is between 1.8 and 2.1, and most preferably Z is between 1.8 and 2.0. The alloys are generally single phase materials, exhibiting a hexagonal Laves phase crystalline structure.

In another embodiment, the hydrogen storage material may be chosen from the Ti—V—Zr—Ni active materials such as those disclosed in U.S. Pat. No. 4,551,400 issued to Sapru, et al. on Nov. 5, 1985 (“the '400 patent”), which is hereby incorporated herein by reference. The materials used in the '400 patent utilize a generic Ti—V—Ni composition, where at least Ti, V, and Ni are present with at least one or more of Cr, Zr, and Al. The materials of the '400 patent are multiphase materials, which may contain, but are not limited to, one or more phases with C₁₄ and C₁₅ type crystal structures.

There are other Ti—V—Zr—Ni alloys which may also be used for the hydrogen storage material of the metal hydride bed. One family of materials are those described in U.S. Pat. No. 4,728,586 issued to Venkatesan, et al. on Mar. 1, 1988 (“the '586 patent”), which is hereby incorporated herein by reference. The '586 patent discloses a specific sub-class of these Ti—V—Ni—Zr alloys comprising T, V, Zr, Ni, and a fifth component, Cr. The '586 patent mentions the possibility of additives and modifiers beyond the T, V, Zr, Ni, and Cr components of the alloys, and generally discusses specific additives and modifiers, the amounts and interactions of the modifiers, and the particular benefits that could be expected from them. In addition to the materials described above, hydrogen storage materials for the metal hydride bed may also be chosen from the disordered metal hydride alloy materials that are described in detail in U.S. Pat. No. 5,277,999, to Ovshinsky, et al. on Jan. 11, 1994, which is hereby incorporated herein by reference. Other materials for use in the metal hydride bed are described in U.S. Pat. No. 6,270,719 issued to Fetcenko, et al. on Aug. 7, 2001 and U.S. Pat. No. 6,413,670 issued to Ovshinsky, et al. on Jul. 2, 2002, both of which are hereby incorporated herein by reference.

Since two water molecules are consumed for each borohydride molecule according to reaction (1), the concentration of all the remaining components (the cation, the borate, and the borohydride) will increase as the reaction continues. Therefore, twice as many water molecules as borohydride molecules are needed to sustain a constant rate of reaction. This excess water can be provided to the reaction in two ways: (i) charging the initial metal hydride solution with excess water, i.e., starting with a dilute solution, or (ii) adding more water from a separate source during or after the reaction. The second alternative is preferred to minimize the initial starting weight of water plus borohydride. Adding water from a separate source during or after the reaction is viable because the main byproduct of hydrogen oxidation in a hydrogen-consuming device is water. A hydrogen-consuming device, as used herein, means a device that uses hydrogen as a fuel, such as a fuel cell, combustion engine, or hybrid vehicle as described in U.S. Pat. No. 6,557,655 issued to Ovshinsky et al. on May 6, 2003, which is hereby incorporated herein by reference. The present invention may also be used with a hydrogen-based ecosystem as described in U.S. Pat. No. 6,519,951 issued to Ovshinsky, et al. on Feb. 18, 2003, which is hereby incorporated herein by reference. Preferably, water generated from the hydrogen-consuming device may be added to the borohydride solution. Assuming that water is recycled from the fuel cell or engine, 8 weight units of hydrogen (4 from water and 4 from borohydride) can come from 22 weight units of lithium borohydride. The resulting theoretical hydrogen conversion ratio is 36.36% by weight of hydrogen per unit of borohydride (8/22×100). Therefore, the hydrogen generation system can include a slurry tank to store the borohydride and an adjacent mixing tank to add additional water obtained from the exhaust of the hydrogen consuming device, thereby allowing complete reaction of the borohydride while preventing the borohydride solution from drying out, i.e., preventing the components of the borohydride solution from precipitating out of solution.

The chemical hydride solutions of the present invention preferably include at least one stabilizing agent, since aqueous borohydride solutions slowly decompose unless stabilized. A stabilizing agent, as used herein, is any component, which retards, impedes, or prevents the reaction of metal hydride with water. Typically, effective stabilizing agents maintain chemical hydride solutions at a room temperature (25° C.) pH of greater than about 7, preferably greater than about 11, more preferably greater than about 13, and most preferably greater than about 14.

Useful stabilizing agents include the corresponding hydroxide of the cation part of the metal hydride salt. For example, if sodium borohydride is used as the metal hydride salt, the corresponding stabilizing agent would be sodium hydroxide. Hydroxide concentrations in stabilized metal hydride solutions of the present invention are greater than about 0.1 molar, preferably greater than about 0.5 molar, and more preferably greater than about 1 molar or about 4% by weight. Typically, chemical hydride solutions are stabilized by dissolving a hydroxide in water prior to adding the borohydride salt. Examples of useful hydroxide salts include, but are not limited to, sodium hydroxide, lithium hydroxide, potassium hydroxide, and mixtures thereof. Sodium hydroxide is preferred because of its high solubility in water of about 44% by weight. Although other hydroxides are suitable, the solubility differences between various metal hydrides and various hydroxide salts must be taken into account since such solubility difference can be substantial. For example, adding too much lithium hydroxide to a concentrated solution of sodium borohydride would result in precipitation of lithium borohydride.

Other non-hydroxide stabilizing agents include those that can raise the over-potential of the chemical hydride solution to produce hydrogen. These non-hydroxide stabilizing agents are preferably used in combination with hydroxide salts. Non-limiting examples of non-hydroxide stabilizing agents include compounds containing the softer metals on the right side of the periodic chart. Non-limiting examples of these non-hydroxide stabilizing agents include compounds containing lead, tin, cadmium, zinc, gallium, mercury, and combinations thereof. Compounds containing gallium and zinc are preferred, because these compounds are stable and soluble in the basic medium. For example, zinc and gallium form soluble zincates and gallates, respectively, which are not readily reduced by borohydride.

Compounds containing some of the non-metals on the right side of the periodic chart are also useful in stabilizing metal hydride solutions. Non-limiting examples of these non-hydroxide stabilizing agents include compounds containing sulfur, such as sodium sulfide, thio-urea, carbon disulfide, and mixtures thereof.

### EXAMPLES

Two pieces, A and B, having an area of approximately 10 cm² each were cut from an electrode containing 97% Mm. Piece A had 2.03 g of Mm and piece B had 2.23 g of Mm. Both were immersed in a solution. The solution was made with 5 g of sodium borohydride dissolved in 200 ml de-ionized(DI) water for 2 hour 16 minutes. Then both pieces were taken out quickly and rinsed with DI water.

After rinsing, piece A was put in a beaker containing DI water and heated to 70-80° C. Gas released was collected and measured to be approximately 71 ml at room temperature. B was placed in 30% KOH and discharged. Discharging capacity was measured to be 0.085 Ah with cut-off potential as −0.7 V vs HgO/Hg reference electrode.

A third piece, C, having an area of approximately 10 cm² was cut from an electrode containing 97% Mm. Piece C had 2.14 g of Mm. Piece C was immersed in DI water for 2 hour 16 minutes. Then it was heated to 70-80° C. Gas released was collected and measured to be approximately 12 ml at room temperature. Comparing the results of pieces A and C, the H₂ gas released from piece A was approximately 59 ml.

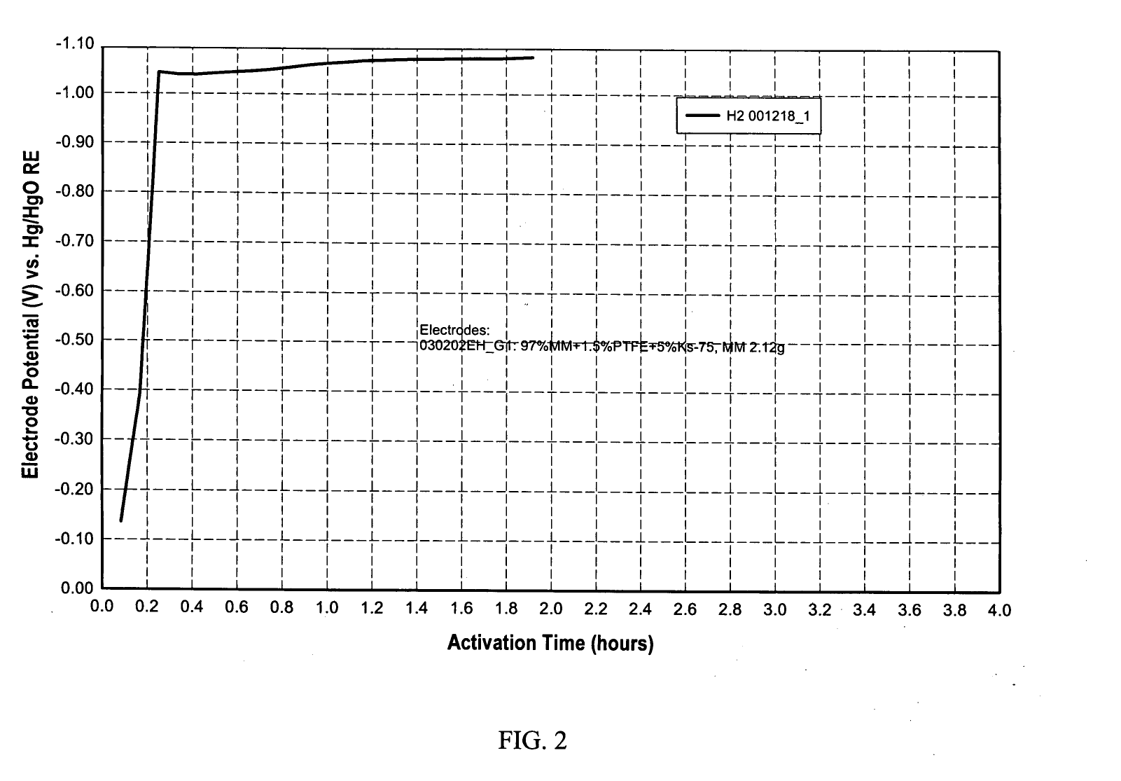

FIG. 2 shows the electrode potential change with time of a Mm electrode after being soaked in a NaBH₄/KOH solution (activation curve). The electrode is constructed of 97% Mm and the NaBH₄/KOH solution is 4.1 g NaBH₄ in 200 mL solution. The activation curve shows the adsorption of hydrogen by Mm (as electrode potential goes negative).

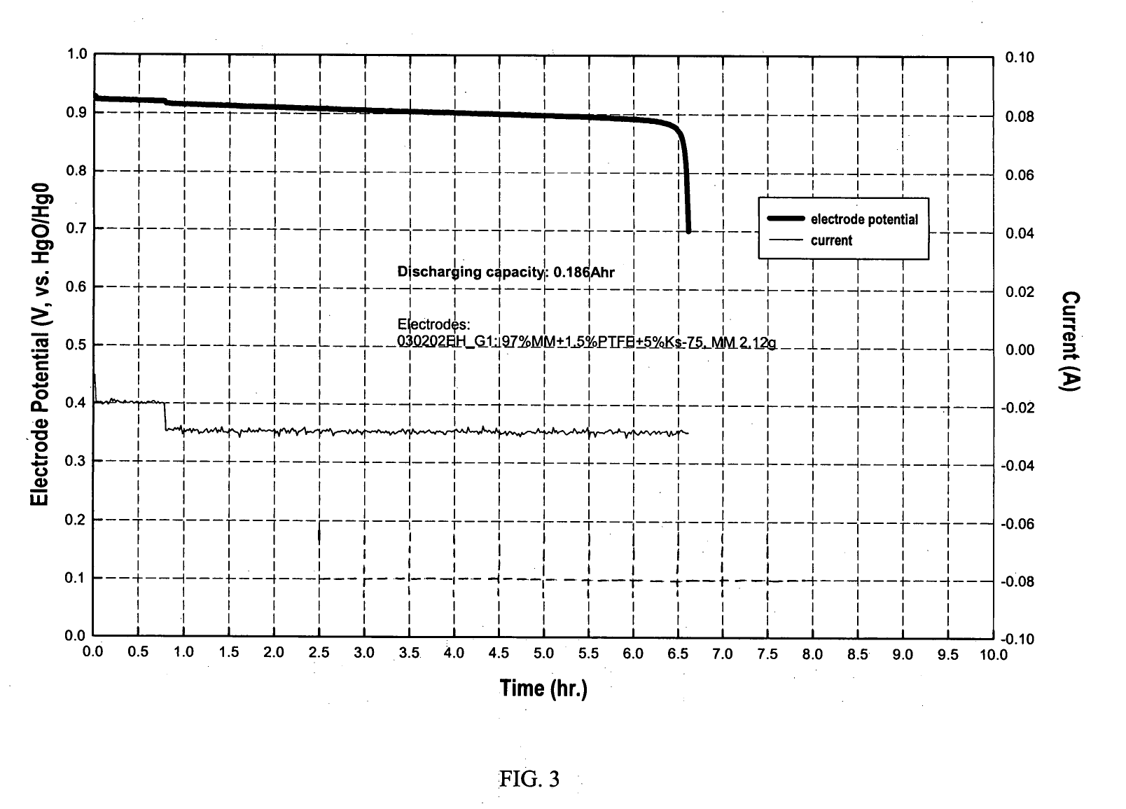

FIG. 3 shows the polarization curves of the Mm electrode in a NaBH₄/KOH solution. The electrode is constructed of 97% Mm and the NaBH₄/KOH solution is 4.1 g NaBH₄ in 200 mL solution. The test was done at room temperature. The electrode gave good performance.

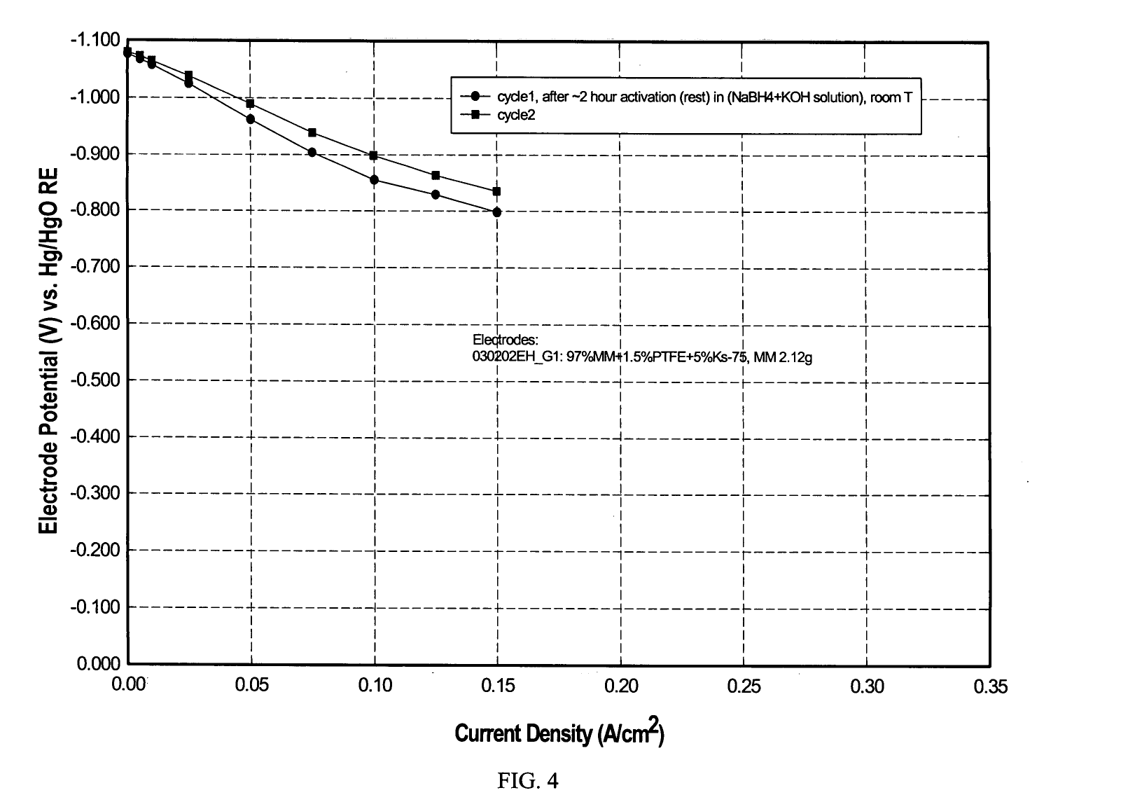

FIG. 4 shows the longer term discharging results of the Mm electrode in NaBH₄/KOH solution at 100 mA/cm². The electrode is constructed of 97% Mm and the NaBH₄/KOH solution is 4.1 g NaBH₄ in 200 mL solution. Tests in FIGS. 3 and 4 are standard tests for electrodes. Good performance indicates that the Mm electrodes are good at adsorbing hydrogen from NaBH₄ solution and/or good catalysts for NaBH₄ oxidation.

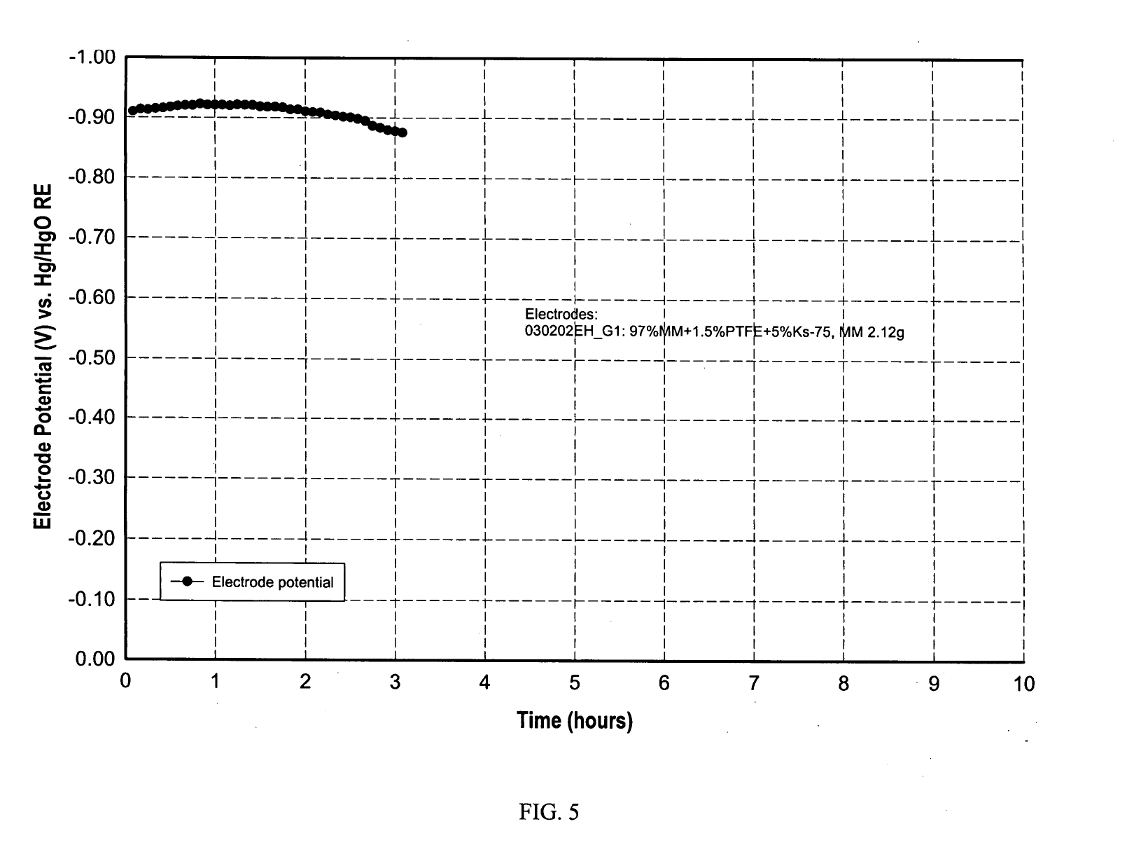

FIG. 5 was done by taking the Mm electrode out of the NaBH₄/KOH solution, rinsing it by deionized water and then discharging it in KOH solution without NaBH₄. The discharge capacity indicates that Mm adsorbed hydrogen and the adsorbed hydrogen could be released electrochemically.

While the invention has been illustrated in detail in the drawings and the foregoing description, the same is to be considered as illustrative and not restrictive in character as the present invention. It will be apparent to those skilled in the art that variations and modifications of the present invention can be made without departing from the scope or spirit of the invention. For example, the hydrogen storage material and catalysts, the components of the chemical hydride slurry, the type of containers for the metal hydride bed and chemical slurry and the manner in which the slurry is made to contact the metal hydride bed can be varied without departing from the scope and spirit of the invention. Further more, by using one or more of the embodiments described above in combination or separately, it is possible to charge a metal hydride bed without the need for high pressure and coolant, so that a safer and more efficient charging system is realized. Thus, it is intended that the present invention cover all such modifications and variations of the invention, that come within the scope of the appended claims and their equivalents.

1. A process for charging a metal hydride bed, comprising:
providing a first container in first flow communication with a second container;
providing a chemical hydride slurry in said first container;
providing said metal hydride bed in said second container, said metal hydride bed comprising a hydrogen storage material, said first flow communication flowing slurry from said first container to said second container;
contacting said slurry with said metal hydride bed in said second container, said contacting promoting a reaction between in said slurry, said reaction producing atomic hydrogen and byproducts, wherein at least a portion of said atomic hydrogen is absorbed and stored by said metal hydride bed.

2. The process of claim 1, said chemical hydride slurry comprising:
a metal hydride;
a stabilizing agent; and
water.

3. The process of claim 1, said contacting comprising pumping said slurry from said first container to said second container.

4. The process of claim 3, further comprising pumping said slurry and said byproducts from said second container into said first container through a second flow communication between said first container and said second container.

5. The process of claim 4, further comprising pumping said slurry from said first container to said second container until said slurry is free of hydrogen.

6. The process of claim 2, said metal hydride of said slurry comprising sodium borohydride, potassium borohydride, lithium borohydride or a mixture thereof.

7. The process of claim 2, said stabilizing agent comprising sodium hydroxide, potassium hydroxide, lithium hydroxide or a mixture thereof.

8. The process of claim 1, said hydrogen storage material comprising an alloy selected from AB, A₂B, AB₂ or AB₅.

9. The process of claim 1, said hydrogen storage material comprising Mg based alloys, Mg—Ni based alloys, Mg—Cu based alloys, Ti—Fe based alloys, Ti—Ni based alloys, Mm—Co based alloys, Ti—Mn based alloys, Ti—V based alloys, Ti—Cr based alloys, Mm—Ni based alloys or mixtures thereof.

10. The process of claim 1, said hydrogen storage material comprising a Ti_{Q-z}ZrₓMn_{z-y}A_{y} alloy, wherein A comprises at least one of V, Cr, Fe, Ni or Al, wherein Q is between 0.9 and 1.1, X is between 0.0 and 0.35, Y is between 0.6 and 1.8, Z is between 1.8 and 2.1.

11. The process of claim 1, further comprising venting unabsorbed hydrogen.

12. The process of claim 1, further comprising forcing unabsorbed hydrogen to a hydrogen powered apparatus, said apparatus comprising a fuel cell.

13. The process of claim 5, further comprising closing a valve set in first flow communication when said slurry is free of hydrogen.

14. A chemical hydride bed charging system, comprising:
a chemical hydride slurry;
a first container containing said chemical hydride slurry; and
a second container containing said metal hydride bed, said first container in first flow communication with said second container, said first flow communication flowing slurry from said first container to said second container and said metal hydride bed promoting a reaction between in said slurry, said reaction producing atomic hydrogen and byproducts, wherein at least a portion of said atomic hydrogen is absorbed by said metal hydride bed.

15. The system of claim 14, said chemical hydride slurry comprising
a metal hydride,
a stabilizing agent; and
water;

16. The system of claim 15, said reaction comprising a reaction between said metal hydride and said water.

17. The system of claim 14, further comprising a valve, said valve controlling flow from said first container to said second container.

18. The system of claim 14, further comprising a pump, said pump forcing second flow communication between said first container and said second container, said second flow communication flowing byproducts and slurry from said second container to said first container.

19. The system of claim 15, said metal hydride of said slurry comprising sodium borohydride, potassium borohydride, lithium borohydride or a mixture thereof.

20. The system of claim 15, said stabilizing agent comprising sodium hydroxide, potassium hydroxide, lithium hydroxide or a mixture thereof.

21. The system of claim 15, said metal hydride bed comprising a hydrogen storage material, said hydrogen storage material comprising an alloy selected from AB, A₂B, AB₂, AB₅ or mixtures thereof.

22. The system of claim 15, said metal hydride bed comprising a hydrogen storage material, said hydrogen storage material comprising Mg based alloys, Mg—Ni based alloys, Mg—Cu based alloys, Ti—Fe based alloys, Ti—Ni based alloys, Mm—Co based alloys, Ti—Mn based alloys, Ti—V based alloys, Ti—Cr based alloys, Mm—Ni based alloys or mixtures thereof.

23. The system of claim 15, said metal hydride bed comprising a hydrogen storage material, said hydrogen storage material comprising a Ti_{Q-Z}Zr_{X}Mn_{Z-Y}A_{Y} alloy, wherein A comprises at least one of V, Cr, Fe, Ni or Al, wherein Q is between 0.9 and 1.1, X is between 0.0 and 0.35, Y is between 0.6 and 1.8, Z is between 1.8 and 2.1.

24. The system of claim 14, said metal hydride bed comprising:
a catalyst to promote said reaction; and
a hydrogen storage material to absorb atomic hydrogen.

25. The system of claim 24, said hydrogen storage material comprising said catalyst.
